(19) United States
(12) Patent Application Publication
(10) Pub. No.: US 2009/0297918 A1
(43) Pub. Date: Dec. 3, 2009

(54) Board material for fuel cell metallic separator, method of making same, and fuel cell metallic separator

(75) Inventors: Takaaki Sasaoka, Tsuchiura (JP); Masahiro Seidou, Tsuchiura (JP); Kazuhiko Nakagawa, Tsuchiura (JP); Mineo Washima, Tsuchiura (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: Hitachi Cable, Ltd., Tokyo (JP)

(21) Appl. No.: 12/320,699

(22) Filed: Feb. 2, 2009

(30) Foreign Application Priority Data
Jun. 3, 2008 (JP) 2008-145976

(51) Int. Cl. H01M 2/16; B32B 15/01; H01M 2/18

(52) U.S. Cl. 429/34; 428/660; 427/115

(57) ABSTRACT

A board material for a fuel cell metallic separator includes a metallic substrate, an intermediate layer formed on a surface of the metallic substrate, and including titanium (Ti), and a Au layer formed on a surface of the intermediate layer, including pure gold (Au), and having an average thickness of not less than 1 nm and not more than 9 nm. A fuel cell metallic separator includes the board material that includes a concavo-convex shape.

The present application is based on Japanese patent application No.2008-145976 filed Jun. 3, 2008, the entire contents of which are incorporated herein by reference.

### BACKGROUND OF THE INVENTION

1. Field of the Invention

This invention relates to a board material for a fuel cell metallic separator, in particular, to a board material adapted to produce a metallic separator improved in durability, a method of making a board material for a fuel cell metallic separator, and a fuel cell metallic separator.

2. Description of the Related Art

FIG. 8 is an exploded perspective view schematically showing a unit cell of conventional polyelectrolyte fuel cell with separators. The unit cell of polyelectrolyte fuel cell 71 (hereinafter referred to as “unit fuel cell”) is composed of an MEA (membrane electrode assembly) 75 including a polyelectrolyte membrane, a fuel electrode (hydrogen electrode or anode) and an oxidant electrode (air electrode or cathode), a separator 77 on the hydrogen electrode side where a fuel gas channel 76 is formed facing one surface (or fuel electrode) of the MEA 75, a separator 79 on the air electrode side where an oxidant gas channel 78 is formed facing the other surface (or oxidant electrode) of the MEA 75, and gaskets 80 disposed being sandwiched between the MEA 75 and the separator 77 or 79 for sealing the periphery of the MEA 75.

The fuel electrode is disposed on one surface of the polyelectrolyte membrane 72, and includes an anode-side catalyst layer and a gas diffusion (dispersion) layer 81 disposed outside the anode-side catalyst layer. The oxidant electrode is disposed on the other surface of the polyelectrolyte membrane 72, and includes a cathode-side catalyst layer and a gas diffusion (dispersion) layer 81 disposed outside the cathode-side catalyst layer. The separators 77, 79 are each a member for providing the electrical connection between the fuel electrode and the oxidant electrode, and for preventing the fuel and the oxidant from mixing.

It is preferable that the contact resistance between the MEA 75 and the metallic separator 77 or 79 is low in terms of an decrease in internal loss of the unit fuel cell 71, and it is required to be not more than about 150 Ω·cm². The contact resistance is more preferably not more than 100 mΩ·cm² and most preferably not more than 70 mΩ·cm².

The unit fuel cell 71 generates electric power through an electrochemical reaction using hydrogen in the fuel gas and oxygen in the oxidant gas under the temperature condition of about 80° C. When hydrogen in the fuel gas flowing through the fuel gas channel 76 contacts the anode-side catalyst layer of the fuel electrode, reactions shown in the following formulas occur.

2H₂→4H⁺+4e⁻

Hydrogen ion H⁺ moves to the counter electrode side through the polyelectrolyte membrane 72, reaches the cathode-side catalyst layer, and reacts with oxygen in the oxidant gas flowing through the oxidant gas channel 78 to produce water.

4H⁺+4e⁻+O₂→2H₂O

Electromotive force generated by the above electrode reactions is extracted through the separators 77, 79.

In general, a separator material needs to have corrosion resistance and electrical conductivity in the direction of penetrating through the surface thereof. Typically, a corrosion-resistant metal such as a stainless steel (SUS) is used as a separator material so as to provide the corrosion resistance, and the surface is coated with a noble metal so as to provide the electrical conductivity in the direction of penetrating through the surface. Thus, both of the corrosion resistance and the electrical conductivity in the direction of penetrating through the surface can be satisfied.

As an example of ordinary countermeasure, patent literature 1 mentioned below discloses a method that a stainless steel material or a titanium (Ti) material is coated with a layer of a noble metal or alloy thereof and 1 to 40 nm in thickness for reducing the noble metal usage as much as possible. However, a comparative experiment carried out by the inventors exhibits that even if the noble metal film is directly formed on a metallic board material with Ti covering, the contact resistance of the separator increases with time, particularly in terms of actual durability of about 150 to 500 hours, so that the material is difficult to apply to the separator under the condition to require the durability of more than 150 hours.

In general, there is a big problem such as an adhesion failure in plating a noble metal on a metallic Ti board material, since Ti is a typical example of poorly plated material. Several methods for plating the noble metal on the metallic Ti board material being the poorly plated material are disclosed as below.

Patent literature 2 mentioned below discloses a method for plating Au or an Au—Pd alloy on a metallic Ti board material, wherein the metallic Ti board material is acid-washed before plating for removing the passive layer of the Ti board material, and a film of the noble metal is then formed directly thereon.

Patent literature 3 mentioned below discloses a method that a metallic board material is formed of a stainless steel, Al or Ti, an adhesion layer is formed thereon which can be Ti, Zr, Hf, V, Nb, Ta, Cr, Mo, W, Si, or B or alloy thereof, and a noble metal layer of about 10 nm to 10 μm in thickness is formed as a conductive noble metal on the adhesion layer. Patent literature 3 discloses an example of the adhesion layer of Cr.

Patent literature 4 (claim 8) mentioned below discloses a method that an adhesion layer which can be Ti, Ni, Ta, Nb or Pt is formed on a board material with Ti covering, and a noble metal layer is formed thereon which can be Au or the like and less than 0.0005 to 0.01 μm in thickness. The above methods of forming the adhesion layer as an underlying layer for the noble metal plating would be effective.

Related arts to the invention are as below.

Patent literature 1: JP-A-2004-127711

Patent literature 2: JP-A-2007-146250

Patent literature 3: JP-A-2004-185998

Patent literature 4: JP-A-2004-158437

The surface structure of a metallic separator includes a surface (anode surface) exposed to a fuel and a surface (cathode surface) exposed to an oxidant. At both of the electrode surfaces, exposure to the cell environment for long hours may cause an increase in contact resistance of the metallic separator.

At the anode surface, the durability of the metallic separator is impaired by being exposed to the hydrogen gas environment where the structure and the method as described in the above patent literatures cause hydrogen absorption which incurs reduction in durability. At the cathode surface, although not directly exposed to the hydrogen gas environment, hydrogen absorption may occur when exposed to the cell environment for long hours.

### SUMMARY OF THE INVENTION

It is an object of the invention to provide a board material for a fuel cell metallic separator adapted to produce a fuel cell metallic separator decreased in noble metal usage and improved in durability, according to two kinds of environment (anode surface and cathode surface) of fuel cell, where the surfaces of a metallic substrate are thinly coated with a noble metal, by selecting the necessary thickness of the noble metal coating, the kind of the noble metal, the production method of the coating, and the coating structure in terms of durability. It is a further object of the invention to provide a method of making the board material for the fuel cell metallic separator, and a fuel cell metallic separator.
(1) According to one embodiment of the invention, a board material for a fuel cell metallic separator comprises:

a metallic substrate;

an intermediate layer formed on a surface of the metallic substrate, and comprising titanium (Ti); and

a Au layer formed on a surface of the intermediate layer, comprising pure gold (Au), and having an average thickness of not less than 1 nm and not more than 9 nm.

In the above embodiment (1), the following modifications and changes can be made.

(i) The intermediate layer comprises not more than 5 wt % of palladium (Pd) relative to a Ti content thereof.
(2) According to another embodiment of the invention, a board material for a fuel cell metallic separator comprises:

a metallic substrate;

a lower intermediate layer formed on a surface of the metallic substrate, and comprising titanium (Ti);

an upper intermediate layer formed on a surface of the lower intermediate layer, comprising a Pd layer, and having an average thickness of not more than 1 nm; and

a Au layer formed on the surface of the upper intermediate layer, comprising pure gold (Au), and having an average thickness of not less than 1 nm and not more than 9 nm.
(3) According to another embodiment of the invention, a board material for a fuel cell metallic separator for covering an oxidant electrode side of an MEA (membrane electrode assembly) comprises:

a metallic substrate;

an intermediate layer formed on the surface of the metallic substrate, and comprising titanium (Ti); and

a Au layer formed on the surface of the intermediate layer, comprising pure gold (Au), and having an average thickness of not less than 2 nm and not more than 15 nm.

In the above embodiment (3), the following modifications and changes can be made.

(ii) The intermediate layer comprises not more than 20 wt % of palladium (Pd) to the Ti content thereof.
(4) According to another embodiment of the invention, a board material for a fuel cell metallic separator for covering an oxidant electrode side of an MEA (membrane electrode assembly) comprises:

a metallic substrate;

a lower intermediate layer formed on a surface of the metallic substrate, comprising titanium (Ti);

an upper intermediate layer formed on a surface of the lower intermediate layer, comprising a Pd layer, and having an average thickness of not more than 2 nm; and

a Au layer formed on a surface of the upper intermediate layer, comprising pure gold (Au), and having an average thickness of not less than 2 nm and not more than 15 nm.
(5) According to another embodiment of the invention, a fuel cell metallic separator comprises:

the board material according to any one of the embodiments 1 to 4,

wherein the board material comprises a concavo-convex shape.
(6) According to another embodiment of the invention, a method of making a board material for a fuel cell metallic separator comprises:

forming an intermediate layer on a surface of a metallic substrate by a gas-phase process in a chamber, the intermediate layer comprising titanium (Ti); and

forming a Au layer on a surface of the intermediate layer by a gas-phase process in the same chamber, the Au layer comprising pure gold (Au) and having an average thickness of not less than 1 nm and not more than 9 nm.

In the above embodiment (6), the following modifications and changes can be made.

(iii) The intermediate layer comprises not more than 5 wt % of palladium (Pd) relative to a Ti content thereof.
(7) According to another embodiment of the invention, a method of making a board material for a fuel cell metallic separator comprises:

forming a lower intermediate layer on a surface of a metallic substrate by a gas-phase process in a chamber, the intermediate layer comprising titanium (Ti);

forming an upper intermediate layer on a surface of the lower intermediate layer, the upper intermediate layer comprising a palladium (Pd) layer and having an average thickness of not more than 1 nm; and

forming a Au layer on a surface of the upper intermediate layer by a gas-phase process in the same chamber, the Au layer comprising pure gold (Au) and having an average thickness of not less than 1 nm and not more than 9 nm.
(8) According to another embodiment of the invention, a method of making a board material for a fuel cell metallic separator for covering an oxidant electrode side of an MEA (membrane electrode assembly) comprises:

forming an intermediate layer on a surface of a metallic substrate by a gas-phase process in a chamber, the intermediate layer comprising titanium (Ti); and

forming a Au layer on a surface of the intermediate layer by a gas-phase process in the same chamber, the Au layer comprising pure gold (Au) and having an average thickness of not less than 2 nm and not more than 15 nm.

In the above embodiment (8), the following modifications and changes can be made.

(iv) The intermediate layer comprises not more than 20 wt % of palladium (Pd) relative to a Ti content thereof.
(9) According to another embodiment of the invention, a method of making a board material for a fuel cell metallic separator for covering an oxidant electrode side of an MEA (membrane electrode assembly) comprises:

forming a lower intermediate layer on a surface of a metallic substrate by a gas-phase process in a chamber, the intermediate layer comprising titanium (Ti);

forming an upper intermediate layer on a surface of the lower intermediate layer comprising a palladium (Pd) layer and having an average thickness of not more than 2 nm; and

forming a Au layer on a surface of the upper intermediate layer by a gas-phase process in the same chamber, the Au layer comprising pure gold (Au) and having an average thickness of not less than 2 nm and not more than 15 nm.

### ADVANTAGES OF THE INVENTION

According to the invention, a board material for a fuel cell metallic separator allows a decrease in noble metal usage and an improvement in durability, according to the material of the metallic substrate, the usage environment of the cell, and the production volume of the metallic separator.

### BRIEF DESCRIPTION OF THE DRAWINGS

The preferred embodiments according to the invention will be explained below referring to the drawings, wherein:

FIG. 1 is a cross-sectional view schematically showing a board material for a fuel cell metal separator in a first embodiment according to the invention;

FIG. 2A is an exploded perspective view schematically showing a unit cell of a polyelectrolyte fuel cell in an embodiment according to the invention;

FIG. 2B is a side view showing an MEA 21 in FIG. 2A;

FIG. 3 is a cross-sectional view schematically showing a board material for a fuel cell metal separator in a second embodiment according to the invention;

FIG. 4 is a cross-sectional view schematically showing a board material for a fuel cell metal separator in a third embodiment according to the invention;

FIG. 5 is an explanatory diagram schematically showing a method of measuring the resistance of a metal separator;

FIG. 6A is a top view showing a shape of a pressed separator formed as an example;

FIG. 6B is an enlarged cross-sectional view of a part B in FIG. 6A;

FIG. 7 is photographs showing the implementation of simple peeling test; and

FIG. 8 is an exploded perspective view schematically showing a unit cell of a conventional polyelectrolyte fuel cell.

### DETAILED DESCRIPTION OF THE PREFERRED EMBODIMENTS

The preferred embodiments according to the invention will be explained below referring to the drawings.

First, a unit cell of a polyelectrolyte fuel cell using a metallic separator in an embodiment according to the invention will be described with reference to FIGS. 2A and 2B.

As shown in FIGS. 2A and 2B, a unit cell 20 of a polyelectrolyte fuel cell includes a MEA 21 having a board-like shape, metallic separators 22a, 22b formed on both sides of the MEA 21, and gaskets 23a, 23b formed so as to be sandwiched between the MEA 21 and the separators 22a, 22b for sealing the periphery of MEA 21.

The MEA 21 includes a polyelectrolyte membrane 24, a fuel electrode (anode) 25a formed on one surface of the polyelectrolyte membrane 24 and an oxidant electrode (cathode) 25b formed on another surface of the polyelectrolyte membrane 24.

The fuel electrode includes a catalyst layer of anode side and a gas diffusion (dispersion) layer 26a formed so as to be sandwiched between the catalyst layer of anode side and the gasket 23a. The oxidant electrode 25b includes a catalyst layer of cathode side and a gas diffusion (dispersion) layer 26b formed so as to be sandwiched between the catalyst layer of cathode side and the gasket 23b.

The separator 22a of the anode side has a fuel gas channel 27a with a concave groove-like shape formed facing one surface of the MEA 21 (fuel electrode 25a). The separator 22b of the cathode side has an oxidant gas channel 27b with a concave groove-like shape formed facing the other surface of the MEA 21 (oxidant electrode 25b).

The multiple unit cells 20 of a polyelectrolyte fuel cell are stacked to form a fuel cell.

Hereinafter, a board material for a metallic separator in an embodiment according to the invention will be described.

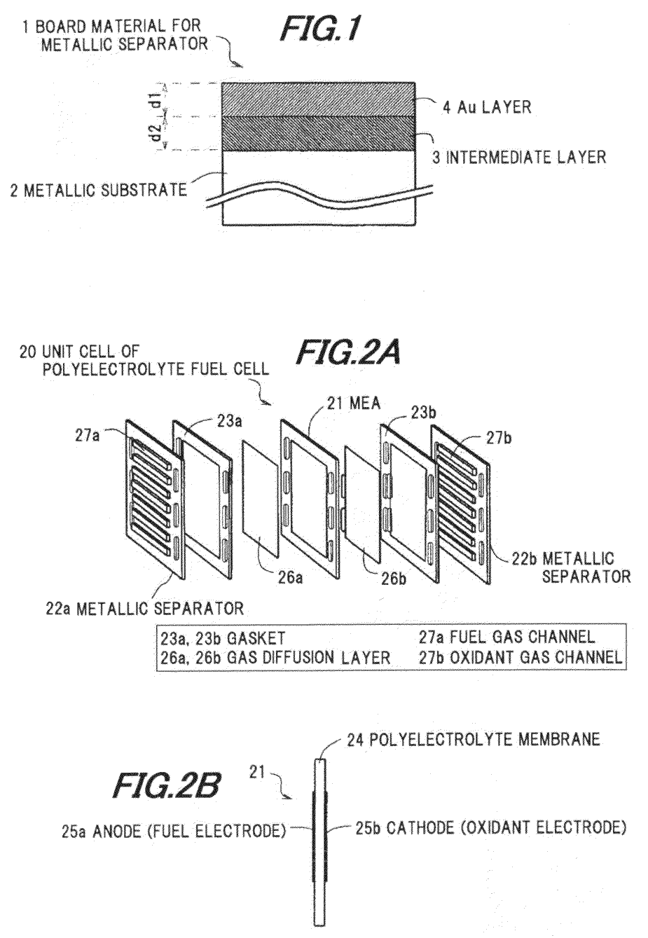

As shown in FIG. 1, the board material 1 for a metallic separator according to a first embodiment includes a metallic substrate 2, an intermediate layer 3 formed on the surface of the metallic substrate 2, the layer 3 including titanium (Ti) as a main component, and an Au layer 4 formed on the surface of the intermediate layer 3, the layer 4 composed of gold (Au).

The metal substrate 2 includes a Ti material, a Ti alloy material, or a metal material coated with Ti (for example, a composite material formed by clad-coating both surfaces of SUS with Ti).

The intermediate layer 3 functions as an adhesion layer for connecting the metallic substrate 2 and the Au layer 4. The intermediate layer 3 includes a Ti material or a Ti alloy material. The intermediate layer 3 has a palladium (Pd) concentration of not more than 5 wt % (when 0 wt %, pure Ti) to the Ti content thereof.

If the intermediate layer 3 has an average thickness d2 of less than 2 nm, an increase in contact resistance may be caused. If the intermediate layer 3 has an average thickness d2 of more than 100 nm, peeling (or separation) from the metallic substrate 2 is likely to occur. Therefore, it is preferable that the average thickness d2 of the intermediate layer 3 is from 5 nm to 100 nm.

If the intermediate layer 3 is formed of a material selected from Zr, Ta or Cr, it causes an increase in contact resistance of the board material 1 for a metallic separator under the cell environment, however, if the material is selected from a Ti material or a Ti—Pd alloy, it can prevent the contact resistance from increasing.

Particularly, the addition of Pd to the intermediate layer 3 provides the following three advantages.

(1) If Pd is mixed into the intermediate layer 3 as a component, an adhesion between the intermediate layer 3 and Au layer 4 can be improved in comparison with the case that Pd is not mixed. This is attributed to the fact that Au itself does not combine chemically with most of another metals, but if Pd which has a large chemical activity exists in the intermediate layer 3, the chemical combining power between the intermediate layer 3 and Au layer 4 can be improved.

(2) Pd has a corrosion resistance to fluoride exhausted in minute amounts in the environment of the fuel cell. Thus, the intermediate layer 3 can be improved in durability and subsequently, can prevent the Au layer 4 formed on the surface of intermediate layer 3 from peeling (separating) and leaking out, so that the Au layer 4 can be also improved in durability.

(3) If Pd atoms exist near the Ti layer (intermediate layer 3), the formation of oxide layer on the Ti layer is accelerated. The oxide layer acts as a hydrogen barrier, can reduce hydrogen absorption caused by generation of hydrogen gas associated with metal corrosion and then can prevent the peeling of the Ti layer from the metal substrate 2, so that the board material for a metallic separator can be improved in durability.

The Au layer 4 functions as an electric contact layer for increasing the contact resistance. The Au layer 4 causes a problem of peeling, if it is placed for a long time under the environment of the fuel cell, in the situation that Pd which is one of the other kinds of noble metals is mixed thereto as an impurity in Au.

If the average thickness of the Au layer 4 is less than 1 nm, the Au layer 4 causes an increase in contact resistance, since an oxide layer is formed on the Ti layer due to moisture in the environment of the anode cell (moisture+hydrogen gas) and the oxide layer grows not less than 1 nm in the average thickness due to a repeated use for a long time.

Further, if the average thickness of the Au layer 4 is more than 9 nm, the Au layer 4 causes an increase in strain thereof so as to easily peel from the metallic substrate 2. The enlargement of strain of the Au layer 4 is caused by volume expansion of Ti due to hydrogen gas absorption of the intermediate layer 3.

Since the volume expansion of Ti layer due to the hydrogen absorption becomes remarkably in the anode environment (because of the hydrogen gas environment), the average thickness of the Au layer 4 is to be not less than 1 nm and not more than 9 mn.

Hereinafter, a method of making a board material 1 for a metallic separator in an embodiment according to the invention will be described.

The method of making the board material 1 for a metallic separator including the first step of preparing a metallic substrate 2, the second step of fabricating a material member by forming an intermediate layer 3 on the surface of the metallic substrate 2 by a gas-phase process using a chamber, the intermediate layer 3 including titanium (Ti) as a main component and including not more than 5 wt % (when 0 wt %, pure Ti) of palladium (Pd) to the Ti content thereof, and forming an Au layer 4 on the surface of the intermediate layer 3 by a gas-phase process in the same chamber, the Au layer 4 comprising pure gold or fine gold (Au), and the third step of carrying out a press forming of the material member. The gas-phase process includes processing technologies such as deposition, ion beam, sputtering or CVD.

Either of the first step and the second step can be carried out prior to the other so as to obtain the board material 1 for a metallic separator. Further, if the metallic substrate 2 is subjected to a concavo-convex processing which is a process for forming a concavo-convex shape, a metallic separator for a fuel cell can be obtained.

Hereinafter, an operation of the first embodiment according to the invention will be described.

In the board material 1 for a metallic separator, when Pd is added to the intermediate layer 3, the Au layer 4 is not likely to peel from the metallic substrate 2 as compared to the case of not adding Pd thereto since the intermediate layer 3 with Pd added thereto can chemically bond the Au layer 4 tightly to the metal substrate 2.

In addition to the above, if Pd is added to the intermediate layer 3, the Au layer 4 can be prevented from leaking out. Further, the intermediate layer 3 with Pd added thereto prevents hydrogen absorption so that the intermediate layer 3 is not likely to peel from the metallic substrate 2.

Thus, the board material 1 for a metallic separator is capable of realizing a metallic separator improved in durability, according to the kind of material of the metallic substrate, the usage environment (anode surface or cathode surface) of the metallic separator for the fuel cell, the price and the production volume of the metallic separator.

In the board material 1 for a metallic separator, the intermediate layer 3 is set to 5 to 100 nm in the average thickness d2 and the Au layer 4 is set to 1 to 9 nm in the average thickness d1, so that it can be improved in durability and can be decreased in the noble metal usage.

The board material 1 for a metallic separator can be used for both sides of anode and cathode, but particularly, it is preferable to be used for the anode side.

According to the making method in the embodiment, the board material 1 for a metallic separator can be fabricated easily and appropriately.

Hereinafter, a second embodiment according to the invention will be described.

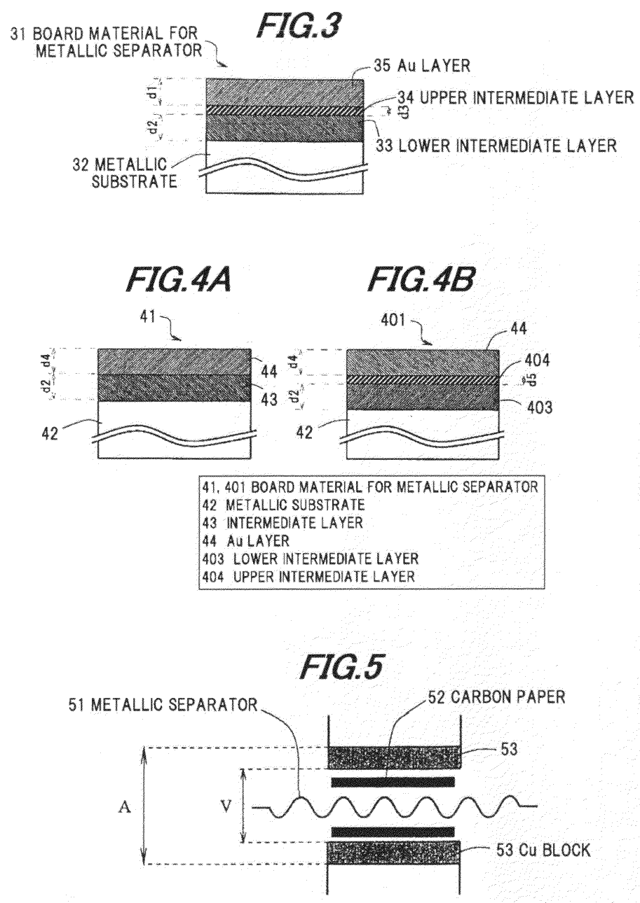

As shown in FIG. 3, the board material 31 for a metallic separator according to a second embodiment includes a metallic substrate 32, a lower intermediate layer 33 formed on the surface of the metallic substrate 32, the layer 33 composed of pure titanium (Ti), and an upper intermediate layer 3 formed on the surface of the lower intermediate layer 33, the layer 34 composed of pure Pd.

The lower intermediate layer 33 functions as a close contact layer for making the metallic substrate 32 and the upper intermediate layer 34 closely contact, and the upper intermediate layer 34 functions as an adhesion layer for connecting the lower intermediate layer 33 and an Au layer 35. The lower intermediate layer 33 has the same average thickness as the intermediate layer 3 of the board material 1 for a metallic separator shown in FIG. 1 has as the average thickness d2.

Since the upper intermediate layer 34 includes Ti, if the average thickness d3 is not more than 1 nm, the layer 34 can prevent hydrogen absorption, but if the average thickness d3 is more than 1 nm, increase in the hydrogen absorption may be caused. Therefore, the average thickness d3 of the upper intermediate layer 34 is set to not more than 1 nm (the case of “d3 is 0 mn” is excluded since it has the same meaning as the case of “the Pd concentration of the intermediate layer 3 is 0 wt % in the board material 1 for a metallic separator shown in FIG. 1”)

The reason why the average thickness d3 of the upper intermediate layer 34 is set to not more than 1 nm is that if Pd atoms become a polyatomic layer (more than 1 nm in thickness), stress-strain occurs among the Pd atoms so that this local strain becomes a factor for hydrogen absorption. On the other hand, if the Pd atoms are comparable in size to about monoatom (approximately not more than 1 nm in thickness), stress-strain among the Pd atoms is extremely decreased (in case of perfect monoatom, stress-strain among the Pd atoms is zero), so that the hydrogen absorption which occurs in case of the Pd polyatomic layer, does not occur.

The method of making the board material 31 can be carried out, instead of forming the intermediate layer 3 in the second step of the method of making the board material 1 for a metallic separator shown in FIG. 1, according to the steps of forming the lower intermediate layer 33 and then forming the upper intermediate layer 34 having the average thickness d3 of not more than 1 nm (the case of “d3 is 0 nm” is excluded since it has the same meaning as the case of “the Pd concentration of the intermediate layer 3 is 0 wt % in the board material 1 for a metallic separator shown in FIG. 1”) so as to result in forming the intermediate layer 3.

The board material 31 for a metallic separator has an advantage that the board material 1 for a metallic separator has originally and additional advantages that the lower intermediate layer 33 provides by functioning as the close contact layer between the metallic substrate 32 and the upper intermediate layer 34, and the upper intermediate layer 34 provides by functioning as the adhesion layer between the lower intermediate layer 33 and the Au layer 35, so that it can improve durability.

Hereinafter, a board material for a metallic separator used for the cathode side in an embodiment according the invention will be described.

As shown in FIG. 4A, the board material 41 for a metallic separator according to a third embodiment has a structure similar to the board material 1 for a metallic separator shown in FIG. 1, but the board material 41 is different from the board material 1 in the Pd concentration of the intermediate layer 43 formed on the surface of the metallic substrate 42 and the average thickness d4 of the Au layer 44. The intermediate layer 43 has the palladium (Pd) concentration of not more than 20 wt % (when 0 wt %, pure Ti) to the Ti content thereof. The average thickness d4 of the Au layer 44 is less than 2 nm to 15 nm.

As shown in FIG. 4B, the board material 401 for a metallic separator can also have a structure similar to the board material 31 for a metallic separator shown in FIG. 3, the board material 401 having an intermediate layer including a lower intermediate layer 403 and an upper intermediate layer 404, instead of the intermediate layer 43 in the board material 31. However, the average thickness d5 of the upper intermediate layer 404 is not more than 2 nm (the case of “d5 is 0 nm” is excluded since it has the same meaning as the case of “the Pd concentration of the intermediate layer 43 is 0 wt % in the board material 41 for a metallic separator shown in FIG. 4A”).

If the average thickness d4 of the Au layer 44, 404 is less than 2 nm, the Au layer 44, 404 causes an increase in contact resistance, since an oxide layer is formed on the Ti layer due to moisture and oxygen in the environment of the cathode cell (moisture+air gas) and the oxide layer grows not less than 2 nm in the average thickness due to a repeated use for a long time. In case of the cathode environment, the Au layer 44, 404 is used under an environment where an oxygen atom concentration is high, so that the average thickness d4 of the Au layer 44, 404 to be used as an electric contact layer has to be larger than in case of the anode environment.

Further, if the average thickness of the Au layer 44, 404 is more than 15 mn, the Au layer 44, 404 causes an increase in strain so that it is likely to peel from the metallic substrate 42. The reason why the upper limit of the average thickness is larger than in case of the anode environment is that the volume expansion of the intermediate layer 43 due to hydrogen absorption is smaller than in case of the anode environment so that the Au layer 44, 404 is not likely to peel off due to strain accumulation by just that much.

If Pd is added to the intermediate layer 43, the intermediate layer 43 can prevent hydrogen absorption which occurs slightly due to hydrogen gas which produced in minute amounts in the cathode side and hydrogen atoms in the moisture.

Although hydrogen absorption occurs slightly due to hydrogen gas produced in minute amounts and hydrogen atoms in the moisture, it is not so much amount as in case of the anode environment, therefore, it is supposed that if the average thickness d5 of the upper intermediate layer 404 is set to a range of not more than 2 nm, practically there is no problem with durability.

The method of making the board material 41 can be carried out, instead of the method of making the board material 1 for a metallic separator shown in FIG. 1, according to the conditions that when Pd is added to the intermediate layer, the Pd concentration is set to not more than 20 wt % (when 0 wt %, pure Ti) and the Au layer is formed so as to have an average thickness of 2 to 15 nm. Further, if the following intermediate layer is formed instead of the intermediate layer 43, a board material 401 for a metallic separator can be obtained, the intermediate layer including a lower intermediate layer 403 and an upper intermediate layer 404 having an average thickness d5 of not more than 2 nm (the case of “d5 is 0 nm” is excluded since it has the same meaning as the case of “the Pd concentration of the intermediate layer 43 is 0 wt % in the board material 41 for a metallic separator shown in FIG. 4A”).

The board material 41 for a metallic separator according to the embodiment has the same advantage as the board material 1 for a metallic separator and the board material 401 for a metallic separator according to the embodiment has the same advantage as the board material 31 for a metallic separator.

### EXAMPLES

First, a method of preparing samples will be described.

The metallic substrate includes one that uses a board material formed by a clad rolling junction and a finishing rolling of SUS and Ti, and another that uses pure Ti classified as first class(nominal designation in JIS about a quality of Ti) as it is. The former board material of the clad rolling was formed by the steps of preparing a board of SUS430 (thickness: 1 mm) and a board of Ti (thickness: 0.1 mm), forming a structure of Ti/SUS403/Ti by the clad rolling junction, and carrying out a rolling so as to result in obtaining the board material having a thickness j of 0.1 mm as a finishing size. In the finishing size, the thickness of the Ti layer is 0.01 mm (one surface) and the thickness of the SUS430 material as a core layer is 0.08 mm. As the latter board material, Ti material (thickness: 0.1 mm) classified as first class was used.

The intermediate layer and the Au layer were formed by sputtering process. The sputtering process was carried out by using RF sputtering equipment (manufactured by ULVAC, Inc., model number: SH-350). The layers were formed in an argon (Ar) atmosphere and in a pressure of 7 Pa, and RF output was appropriately adjusted according to metal species. Thickness control was carried out every metal species by adjusting the time of layer formation, after preliminarily making a survey of the average speed of layer formation.

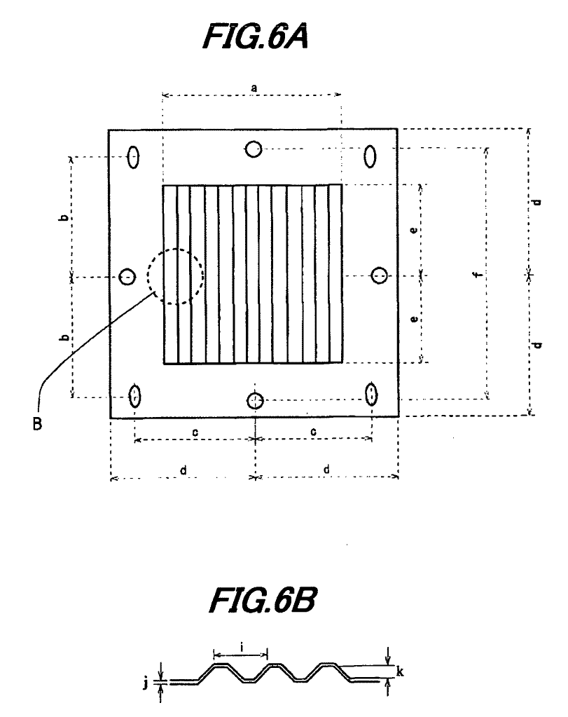

At the end, a press forming work was carried out by using a mold so as to result in obtaining a metallic separator for a fuel cell (See FIG. 6A). In this case, the length of channel (grooves and concavities formed so as to extend vertically in FIG. 6A) for fuel gas (or oxidant gas)(e+e) was set to 52 mm, a pitch a of the channel (See FIG. 6B with reference to details of part B) was set to 2.9 mm (i)×17 (concavities and convexities formed alternately so as to extend vertically in FIG. 6A), and a depth k of the channel (difference in height between concavity and convexity formed so as to extend in the direction of depth in FIG. 6A) was set to 0.6 mm. With regard to the other sizes, b was set to 31 mm, c was set to 30 mm, d was set to 40 mm and f was set to 70 mm.

Next, a method of evaluating durability of samples will be described.

(1) Resistant Measurement of Metal Separator

The durability of the metal separator was evaluated by measuring variations in resistance value (resistance value when it came into contact with the gas diffusion (dispersion) layer of MEA) of various metal separators before and after the cell operation test.

As shown in FIG. 5, in particular, the resistance measurement of metal separator was carried out by that the prepared metal separator 51 (2×2 cm²) was sandwiched between gold-plated copper (Cu) blocks 53 through the carbon papers 52, being subjected to weight bearing (10 kg/cm 2) by a hydraulic press machine, and the resistance R (mΩ) between the metal separator 51 and the carbon papers 52 was measured by a four terminals measuring method (High Speed, 1 kHz, Digital MILLI OHM Meter manufactured by Adex Corporation, part number: AX-125A). The measurement is conducted with current terminal lines (A) and voltage terminal lines (V) connected as shown in FIG. 5. The surface resistance r of the metal separator 51 was obtained from the formula described below.

r(mΩ·cm ²)=R×S (area of the metal separator)×λ(share of surface contact), λ=0.5 in the formula

As the gas diffusion (dispersion) layer of MEA, the carbon paper 52 (manufactured by Toray Industries, Inc., part number: TGP-H-060) was used.

(2) Examination of Hydrogen Absorption Volume Per Ti Layer of Metal Separator and Confirmation of Existence or Nonexistence of Hydrogen Embrittlement

The hydrogen contents of the metal separator were measured after the cell test. The measurement was carried out by burning the samples so as to determine the hydrogen (H) yield generated at the burning. A measurement equipment (manufactured by HORIBA Ltd., model number: EMGA-1110) was used for the measurement of hydrogen contents. Further, a hydrogen content Nt per Ti layer in the samples was calculated from the hydrogen content Nm actually measured, based on the formula described below.

Nm=(Ns·ρsVs+Nt·ρtVt)/(ρsVs+ρtVt)

Namely, this is based on the assumption that Nm which is a value obtained by the experiment complies with a simple composition rule, as a relation among Ns (hydrogen content of SUS layer), Nt (hydrogen content of Ti layer), Vs (volume share of SUS layer) and Vt (volume share of Ti layer). Since the Au layer and the intermediate layer are thinner in thickness than the metallic substrate, they are neglected in the formula.

Further, density ρs of SUS material is equal to 7.8 g/cm³ and density ρt of Ti material is equal to 5 g/cm³, and if a clad material of Ti/SUS/Ti is used as the metallic substrate in the present experiment, Vt is equal to 0.2 and Vs is equal to 0.8 in all cases.

With regard to SUS material, the initial (early-time) Ns was set to be equal to 7 ppm and the after operation Ns (500 to 5000 hours) was set to be equal to 15 ppm.

The hydrogen content of SUS material is a value estimated by carrying out an analysis separately. Further, if pure Ti is used as the metallic substrate, the hydrogen content actually measured was set to be equal to the hydrogen content per Ti layer. In the present measurement, the measurement accuracy is the extent of two digits as effective digit.

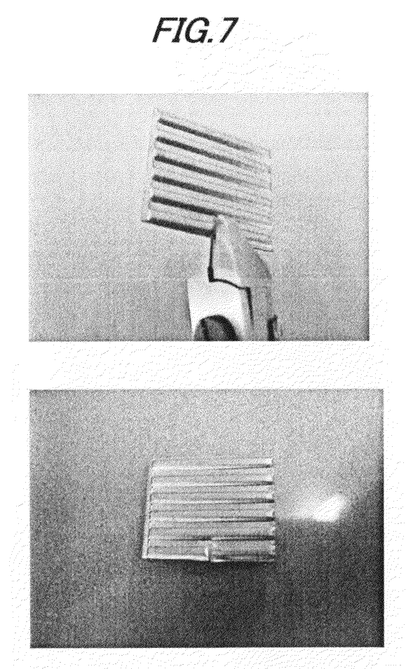

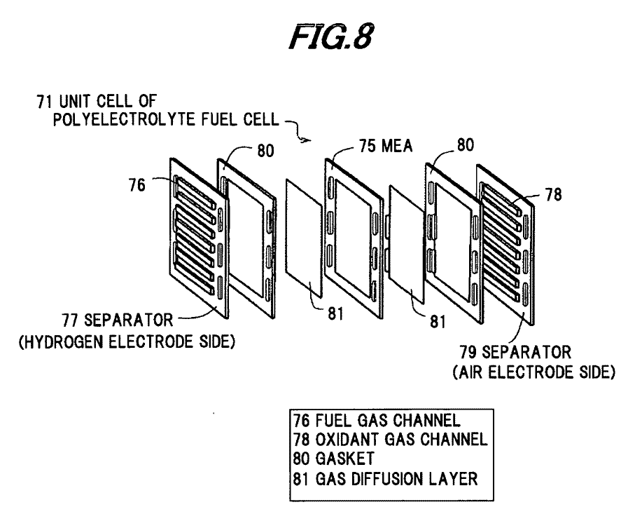

In some samples, there is concern that the hydrogen embrittlement is caused due to hydrogen absorption. In order to investigate the influence of the hydrogen embrittlement, a simple peeling test was carried out. In particular, as shown in FIG. 7, a blade of nipper was placed on the metallic separator in a direction perpendicular to the channel of metallic separator so as to result in cutting off a portion of the sample. The fracture surface formed after the metallic separator was cut off by the nipper was observed by visual contact, and if the surface layer was observed to become brittle so as to be peeled and broken, it was judged as “embrittlement-peeled”. If the surface layer was visually observed not to be peeled and broken after the cutting by the nipper (it has the same surface as a metal material has in case that it is ordinarily cut off), it was judged as “not embrittlement-peeled”.

The conditions of cell operation test used for an evaluation of durability will be described bellow.

As a polyelectrolyte membrane, a fluorine-based (fluorocarbon) polyelectrolyte membrane (sold under a trade name of “Nafion 112” which is a registered trademark, and manufactured by Du Pont) was used, and the size of electric power generation electrode was set to 50×50 mm². As an electrode catalyst, a supported platinum (Pt) catalyst (manufactured by Tanaka Kikinzoku Group, part number: TEC10V50E) was used, and as a gas diffusion (dispersion) layer, a carbon paper (manufactured by Toray Industries, Inc., part number: TGP-H-060) was used. Gaskets were sandwiched so that a fuel cell having a structure shown in FIG. 2A was assembled, the gaskets functioning as a channel formation member for a fuel gas or an oxidant gas and also as a sealing member. With regard to the operation conditions, pure hydrogen was supplied as the fuel gas at a supply speed of 65 cc/min (including moisture at 99 % relative humidity), and air was supplied as the oxidant gas at a supply speed of 260 cc/min (including moisture at 99 % relative humidity). The cell was set to 80 degrees C. as the preset temperature. The cell was power-distributed at unloaded condition, and was operated for 500 hours to 5000 hours.

### Examples A1 to A12

Twelve kinds of samples of the metallic separator using the board material shown in FIG. 1 were prepared by changing the average thickness of the Au layer and simultaneously changing the Pd concentration of pure Ti (Pd concentration is 0 wt %) and Ti—Pd as the intermediate layer within the range of 3 to 5 wt %, and then, fuel cells were assembled by that the above-mentioned samples were used as the anode surface, and further, the fuel cells were subjected to the cell test.

In the present experiment, the metallic separator for the cathode is also required. Therefore, as the metallic separator for the cathode in the present experiment, the same metallic separator as the sample of Example A3 was used.

### Comparative Examples A1 to A19

Nineteen kinds of samples of the metallic separator using the board material shown in FIG. 1 were prepared by changing the average thickness of the Au layer and simultaneously changing the Pd concentration of pure Ti (Pd concentration is 0 wt %) and Ti—Pd as the intermediate layer within the range of 3 to 7 wt %, and then, fuel cells were assembled by that the above-mentioned samples were used as the anode surface, and further, the fuel cells were subjected to the cell test.

Table 1 shows the measurement values of resistance and hydrogen content of the thirty-one kinds of metallic separators before and after the electric power generation, and the result of the simple peeling test of the samples after the operation test.

TABLE 1

| | Thickness of Au | | | | | | | |
|---|---|---|---|---|---|---|---|---|
| | layer | | Resistance of | | | | | |
| | Pd concentration | | separator | | | | | |
| | of intermediate | | (mΩ · cm²) | | | Hydrogen content per Ti layer | | |
| | layer | | | Operation | | (ppm) (result of peeling test) | | |
| | thickness of Au | Pd concentration | | hours | | | Operation hours | |
| Sample name | layer (nm) | (wt %) | Initial | 500 h | 5000 h | Initial | 500 h | 5000 h |
| Comp Ex | 0.3 | 0 | 20 | 40 | 150 | 150 | 7000 | 9000 |
| A1 | | | | | | | (not peeled) | (not peeled) |
| Comp Ex | 0.8 | 0 | 15 | 30 | 120 | 150 | 7000 | 9000 |
| A2 | | | | | | | (not peeled) | (not peeled) |
| Example | 1.0 | 0 | 9 | 12 | 15 | 150 | 7000 | 9000 |
| A1 | | | | | | | (not peeled) | (not peeled) |
| Example | 2.0 | 0 | 8 | 9 | 10 | 150 | 7000 | 9000 |
| A2 | | | | | | | (not peeled) | (not peeled) |
| Example | 5.0 | 0 | 8 | 9 | 9 | 150 | 7000 | 9000 |
| A3 | | | | | | | (not peeled) | (not peeled) |
| Example | 9.0 | 0 | 8 | 9 | 10 | 150 | 7000 | 9000 |
| A4 | | | | | | | (not peeled) | (not peeled) |
| Comp Ex | 10 | 0 | 8 | 12 | 20 | 150 | 7000 | 9000 |
| A3 | | | | | | | (not peeled) | (not peeled) |
| Comp Ex | 12 | 0 | 8 | 12 | 30 | 150 | 7000 | 9000 |
| A4 | | | | | | | (not peeled) | (not peeled) |
| Comp Ex | 0.8 | 3 | 15 | 40 | 120 | 150 | 1000 | 1500 |
| A5 | | | | | | | (not peeled) | (not peeled) |
| Example | 1.0 | 3 | 9 | 12 | 14 | 150 | 1000 | 1500 |
| A5 | | | | | | | (not peeled) | (not peeled) |
| Example | 2.0 | 3 | 8 | 9 | 10 | 150 | 1000 | 1500 |
| A6 | | | | | | | (not peeled) | (not peeled) |
| Example | 9.0 | 3 | 8 | 9 | 10 | 150 | 1000 | 1500 |
| A7 | | | | | | | (not peeled) | (not peeled) |
| Comp Ex | 12 | 3 | 8 | 12 | 25 | 150 | 1000 | 1500 |
| A6 | | | | | | | (not peeled) | (not peeled) |
| Comp Ex | 0.8 | 4 | 15 | 35 | 100 | 150 | 1500 | 2000 |
| A7 | | | | | | | (not peeled) | (not peeled) |
| Example | 1.0 | 4 | 9 | 10 | 12 | 150 | 1500 | 2000 |
| A8 | | | | | | | (not peeled) | (not peeled) |
| Example | 9.0 | 4 | 8 | 9 | 10 | 150 | 1500 | 2000 |
| A9 | | | | | | | (not peeled) | (not peeled) |
| Comp Ex | 12 | 4 | 8 | 11 | 23 | 150 | 1500 | 2000 |
| A8 | | | | | | | (not peeled) | (not peeled) |
| Comp Ex | 0.8 | 5 | 15 | 30 | 90 | 150 | 1500 | 2000 |
| A9 | | | | | | | (not peeled) | (not peeled) |
| Example | 1.0 | 5 | 9 | 10 | 11 | 150 | 1500 | 2000 |
| A10 | | | | | | | (not peeled) | (not peeled) |
| Example | 2.0 | 5 | 8 | 9 | 10 | 150 | 1500 | 2000 |
| A11 | | | | | | | (not peeled) | (not peeled) |
| Example | 9.0 | 5 | 8 | 9 | 10 | 150 | 1500 | 2000 |
| A12 | | | | | | | (not peeled) | (not peeled) |
| Comp Ex | 12 | 5 | 8 | 12 | 100 | 150 | 1500 | 2000 |
| A10 | | | | | | | (not peeled) | (not peeled) |
| Comp Ex | 0.8 | 6 | 15 | 40 | 100 | 150 | 2500 | 11000 |
| A11 | | | | | | | (not peeled) | (not peeled) |
| Comp Ex | 1.0 | 6 | 9 | 10 | 30 | 150 | 2500 | 11000 |
| A12 | | | | | | | (not peeled) | (not peeled) |
| Comp Ex | 9.0 | 6 | 8 | 9 | 100 | 150 | 2500 | 11000 |
| A13 | | | | | | | (not peeled) | (not peeled) |
| Comp Ex | 12 | 6 | 8 | 12 | 100 | 150 | 2500 | 11000 |
| A14 | | | | | | | (not peeled) | (not peeled) |
| Comp Ex | 0.8 | 7 | 15 | 40 | 120 | 150 | 15000 | 18000 |
| A15 | | | | | | | (peeled) | (peeled) |
| Comp Ex | 1.0 | 7 | 9 | 12 | 100 | 150 | 15000 | 18000 |
| A16 | | | | | | | (peeled) | (peeled) |
| Comp Ex | 5.0 | 7 | 8 | 12 | 60 | 150 | 15000 | 18000 |
| A17 | | | | | | | (peeled) | (peeled) |
| Comp Ex | 9.0 | 7 | 8 | 12 | 100 | 150 | 15000 | 18000 |
| A18 | | | | | | | (peeled) | (peeled) |
| Comp Ex | 12 | 7 | 8 | 12 | 100 | 150 | 15000 | 18000 |
| A19 | | | | | | | (peeled) | (peeled) |

Notes:
As the metallic substrate of the separator, a material formed by a clad rolling junction and a finishing rolling of SUS and Ti was used.
Comp Ex: Comparative Example

In the experiment, when any one of the following phenomena was caused, the samples were regarded as “not applicable”, where the phenomena includes the cases that resistance of the metallic separator after operation of 5000 hours is not less than 16 mΩ·cm², the hydrogen content per Ti layer is not less than 10000 ppm, and the surface layer is peeled.

As shown in Table 1, with regard to the Au layer, there is no problem with the initial (early-time) properties even if the average thickness becomes not less than 10 nm, however, increase in the resistance value may be caused after a long hours of operation. It is supposed that the reason why the resistance value is increased is that if the thickness is increased, an amount of strain of the layers is also increased, so that the Au layer is peeled.

Further, with regard to the intermediate layer, the influence of the Pd addition was examined, as a result, in both cases of no addition of Pd, and Pd concentration of not less than 6%, the hydrogen content was increased. The examination result shows that the Pd addition can prevent hydrogen absorption more effectively, although it is applicable even if the Pd concentration is zero, since the hydrogen content remains about 9000 ppm.

### Examples B1 to B12

Pure Ti being used as the metallic substrate, samples were prepared similarly to Examples A1 to A12. As the metallic separator for cathode, the same metallic separator as Example B11 was used, and the cell operation test was carried out.

### Comparative Examples B1 to B19

Pure Ti being used as the metallic substrate, samples were prepared similarly to Comparative Examples A1 to A19.

As in Table 1, Table 2 shows the measurement values in case that only the metallic substrate was changed into a pure Ti.

TABLE 2

| | Thickness of Au | | Resistance of | | | | | |
|---|---|---|---|---|---|---|---|---|
| | layer | | separator | | | | | |
| | Pd concentration of | | (mΩ · cm²) | | | Hydrogen content per Ti layer | | |
| | intermediate layer | | | Operation | | (ppm) (result of peeling test) | | |
| | Thickness of Au | Pd concentration | | hours | | | Operation hours | |
| Sample name | layer (nm) | (wt %) | Initial | 500 h | 5000 h | Initial | 500 h | 5000 h |
| Comp Ex | 0.3 | 0 | 20 | 40 | 150 | 98 | 7000 | 9000 |
| B1 | | | | | | | (not peeled) | (not peeled) |
| Comp Ex | 0.8 | 0 | 15 | 30 | 120 | 98 | 7000 | 9000 |
| B2 | | | | | | | (not peeled) | (not peeled) |
| Example | 1.0 | 0 | 9 | 12 | 15 | 98 | 7000 | 9000 |
| B1 | | | | | | | (not peeled) | (not peeled) |
| Example | 2.0 | 0 | 8 | 9 | 10 | 98 | 7000 | 9000 |
| B2 | | | | | | | (not peeled) | (not peeled) |
| Example | 5.0 | 0 | 8 | 9 | 9 | 98 | 7000 | 9000 |
| B3 | | | | | | | (not peeled) | (not peeled) |
| Example | 9.0 | 0 | 8 | 9 | 10 | 98 | 7000 | 9000 |
| B4 | | | | | | | (not peeled) | (not peeled) |
| Comp Ex | 10 | 0 | 8 | 12 | 20 | 98 | 7000 | 9000 |
| B3 | | | | | | | (not peeled) | (not peeled) |
| Comp Ex | 12 | 0 | 8 | 12 | 30 | 98 | 7000 | 9000 |
| B4 | | | | | | | (not peeled) | (not peeled) |
| Comp Ex | 0.8 | 3 | 15 | 40 | 120 | 98 | 1000 | 1500 |
| B5 | | | | | | | (not peeled) | (not peeled) |
| Example | 1.0 | 3 | 9 | 12 | 14 | 98 | 1000 | 1500 |
| B5 | | | | | | | (not peeled) | (not peeled) |
| Example | 2.0 | 3 | 8 | 9 | 10 | 98 | 1000 | 1500 |
| B6 | | | | | | | (not peeled) | (not peeled) |
| Example | 9.0 | 3 | 8 | 9 | 10 | 98 | 1000 | 1500 |
| B7 | | | | | | | (not peeled) | (not peeled) |
| Comp Ex | 12 | 3 | 8 | 12 | 25 | 98 | 1000 | 1500 |
| B6 | | | | | | | (not peeled) | (not peeled) |
| Comp Ex | 0.8 | 4 | 15 | 35 | 100 | 98 | 1500 | 2000 |
| B7 | | | | | | | (not peeled) | (not peeled) |
| Example | 1.0 | 4 | 9 | 10 | 12 | 98 | 1500 | 2000 |
| B8 | | | | | | | (not peeled) | (not peeled) |
| Example | 9.0 | 4 | 8 | 9 | 10 | 98 | 1500 | 2000 |
| B9 | | | | | | | (not peeled) | (not peeled) |
| Comp Ex | 12 | 4 | 8 | 11 | 23 | 98 | 1500 | 2000 |
| B8 | | | | | | | (not peeled) | (not peeled) |
| Comp Ex | 0.8 | 5 | 15 | 30 | 90 | 98 | 1500 | 2000 |
| B9 | | | | | | | (not peeled) | (not peeled) |
| Example | 1.0 | 5 | 9 | 10 | 11 | 98 | 1500 | 2000 |
| B10 | | | | | | | (not peeled) | (not peeled) |
| Example | 2.0 | 5 | 8 | 9 | 10 | 98 | 1500 | 2000 |
| B11 | | | | | | | (not peeled) | (not peeled) |
| Example | 9.0 | 5 | 8 | 9 | 10 | 98 | 1500 | 2000 |
| B12 | | | | | | | (not peeled) | (not peeled) |
| Comp Ex | 12 | 5 | 8 | 12 | 100 | 98 | 1500 | 2000 |
| B10 | | | | | | | (not peeled) | (not peeled) |
| Comp Ex | 0.8 | 6 | 15 | 40 | 100 | 98 | 2500 | 11000 |
| B11 | | | | | | | (not peeled) | (not peeled) |
| Comp Ex | 1.0 | 6 | 9 | 10 | 30 | 98 | 2500 | 11000 |
| B12 | | | | | | | (not peeled) | (not peeled) |
| Comp Ex | 9.0 | 6 | 8 | 9 | 100 | 98 | 2500 | 11000 |
| B13 | | | | | | | (not peeled) | (not peeled) |
| Comp Ex | 12 | 6 | 8 | 12 | 100 | 98 | 2500 | 11000 |
| B14 | | | | | | | (not peeled) | (not peeled) |
| Comp Ex | 0.8 | 7 | 15 | 40 | 120 | 98 | 15000 | 18000 |
| B15 | | | | | | | (peeled) | (peeled) |
| Comp Ex | 1.0 | 7 | 9 | 12 | 100 | 98 | 15000 | 18000 |
| B16 | | | | | | | (peeled) | (peeled) |
| Comp Ex | 5.0 | 7 | 8 | 12 | 60 | 98 | 15000 | 18000 |
| B17 | | | | | | | (peeled) | (peeled) |
| Comp Ex | 9.0 | 7 | 8 | 12 | 100 | 98 | 15000 | 18000 |
| B18 | | | | | | | (peeled) | (peeled) |
| Comp Ex | 12 | 7 | 8 | 12 | 100 | 98 | 15000 | 18000 |
| B19 | | | | | | | (peeled) | (peeled) |

Notes:
As the metallic substrate of the separator, a material composed of pure Ti was used.
Comp Ex: Comparative Example

The structure of board material for a metallic separator and the result of durability test of metallic separator are similar or equal to those in the case of Table 1. It is supposed that the reason why initial (early-time) value of hydrogen content per Ti layer is different from that in the case of Table 1 is that Ti absorbs hydrogen during the process of forming the metallic substrate such as a clad junction.

### Examples C1 to C12

Next, the experimental result in the case that the intermediate layer includes the lower intermediate layer and the upper intermediate layer will be described. The lower intermediate layer composed of pure Ti was prepared. The average thickness of the lower intermediate layer was set to about 10 nm, and samples were prepared by changing the average thickness of the upper intermediate layer composed of pure Pd from 0.1 nm to 1.0 nm.

Further, twelve kinds of samples were prepared by changing the average thickness of the Au layer composed of pure Au (purity: 3N) from 1 nm to 9 nm. And then, fuel cells were assembled by that the above-mentioned samples were used as the anode surface, and further, the fuel cells were subjected to the cell test. As the metallic separator for the cathode in the present experiment, the same metallic separator as the sample of Example C12 was used.

### Comparative Examples C1 to C19

The lower intermediate layer composed of pure Ti was prepared. The average thickness of the lower intermediate layer was set to about 10 nm, and samples were prepared by changing the average thickness of the upper intermediate layer composed of pure Pd from 0.1 nm to 1.7 nm.

Further, nineteen kinds of samples were prepared by changing the average thickness of the Au layer composed of pure Au (purity: 3N) from 0.3 nm to 12 nm. And then, fuel cells were assembled by that the above-mentioned samples were used as the anode surface, and further, the fuel cells were subjected to the cell test. As the metallic separator for the cathode in the present experiment, the same metallic separator as the sample of Example C12 was used.

The present experiment provides evidence that it is a preferably applicable range that the average thickness of the Au layer is 1 nm to 9 nm and the average thickness of the upper intermediate layer is not more than 1 nm.

TABLE 3

| | Thickness of Au | | | | | | | |
|---|---|---|---|---|---|---|---|---|
| | layer | | Resistance of | | | | | |
| | Thickness of upper | | separator | | | | | |
| | intermediate layer | | (mΩ · cm²) | | | Hydrogen content per Ti layer | | |
| | | Thickness of upper | | Operation | | (ppm)(result of peeling test) | | |
| | Thickness of Au | intermediate layer | | hours | | | Operation hours | |
| Sample name | layer (nm) | (nm) | Initial | 500 h | 5000 h | Initial | 500 h | 5000 h |
| Comp Ex | 0.3 | 0.1 | 18 | 35 | 50 | 150 | 7000 | 9000 |
| C1 | | | | | | | (not peeled) | (not peeled) |
| Comp Ex | 0.8 | 0.1 | 13 | 20 | 40 | 150 | 7000 | 9000 |
| C2 | | | | | | | (not peeled) | (not peeled) |
| Example | 1.0 | 0 | 9 | 12 | 15 | 150 | 7000 | 9000 |
| C1 | | | | | | | (not peeled) | (not peeled) |
| Example | 2.0 | 0.1 | 8 | 9 | 10 | 150 | 1000 | 2000 |
| C2 | | | | | | | (not peeled) | (not peeled) |
| Example | 5.0 | 0.1 | 8 | 9 | 9 | 150 | 1000 | 2000 |
| C3 | | | | | | | (not peeled) | (not peeled) |
| Example | 9.0 | 0.1 | 8 | 9 | 10 | 150 | 1000 | 2000 |
| C4 | | | | | | | (not peeled) | (not peeled) |
| Comp Ex | 10 | 0.1 | 8 | 12 | 25 | 150 | 1000 | 2000 |
| C3 | | | | | | | (not peeled) | (not peeled) |
| Comp Ex | 12 | 0.1 | 8 | 12 | 35 | 150 | 1000 | 2000 |
| C4 | | | | | | | (not peeled) | (not peeled) |
| Comp Ex | 0.8 | 0.3 | 13 | 40 | 50 | 150 | 1000 | 1500 |
| C5 | | | | | | | (not peeled) | (not peeled) |
| Example | 1.0 | 0.3 | 9 | 12 | 14 | 150 | 1000 | 1500 |
| C5 | | | | | | | (not peeled) | (not peeled) |
| Example | 9.0 | 0.3 | 8 | 9 | 9 | 150 | 1000 | 1500 |
| C6 | | | | | | | (not peeled) | (not peeled) |
| Comp Ex | 12 | 0.3 | 8 | 9 | 20 | 150 | 1000 | 1500 |
| C6 | | | | | | | (not peeled) | (not peeled) |
| Comp Ex | 0.8 | 0.5 | 13 | 12 | 50 | 150 | 1000 | 1500 |
| C7 | | | | | | | (not peeled) | (not peeled) |
| Example | 1.0 | 0.5 | 9 | 35 | 12 | 150 | 1500 | 2000 |
| C7 | | | | | | | (not peeled) | (not peeled) |
| Example | 9.0 | 0.5 | 8 | 10 | 9 | 150 | 1500 | 2000 |
| C8 | | | | | | | (not peeled) | (not peeled) |
| Comp Ex | 12 | 0.5 | 8 | 9 | 25 | 150 | 1500 | 2000 |
| C8 | | | | | | | (not peeled) | (not peeled) |
| Comp Ex | 0.8 | 0.7 | 13 | 11 | 50 | 150 | 1500 | 2000 |
| C9 | | | | | | | (not peeled) | (not peeled) |
| Example | 1.0 | 0.7 | 9 | 30 | 14 | 150 | 1500 | 2000 |
| C9 | | | | | | | (not peeled) | (not peeled) |
| Example | 9.0 | 0.9 | 8 | 10 | 9 | 150 | 1500 | 1800 |
| C10 | | | | | | | (not peeled) | (not peeled) |
| Comp Ex | 12 | 0.9 | 8 | 9 | 25 | 150 | 1500 | 1800 |
| C10 | | | | | | | (not peeled) | (not peeled) |
| Comp Ex | 0.8 | 1.0 | 13 | 9 | 50 | 150 | 2000 | 2500 |
| C11 | | | | | | | (not peeled) | (not peeled) |
| Example | 1.0 | 1.0 | 9 | 12 | 14 | 150 | 2000 | 2500 |
| C11 | | | | | | | (not peeled) | (not peeled) |
| Example | 9.0 | 1.0 | 8 | 40 | 9 | 150 | 2000 | 2500 |
| C12 | | | | | | | (not peeled) | (not peeled) |
| Comp Ex | 12 | 1.0 | 8 | 10 | 22 | 150 | 3000 | 3000 |
| C12 | | | | | | | (not peeled) | (not peeled) |
| Comp Ex | 0.8 | 1.2 | 15 | 9 | 50 | 150 | 2500 | 11000 |
| C13 | | | | | | | (not peeled) | (not peeled) |
| Comp Ex | 1.0 | 1.2 | 9 | 12 | 20 | 150 | 10000 | 15000 |
| C14 | | | | | | | (not peeled) | (not peeled) |
| Comp Ex | 9.0 | 1.2 | 8 | 40 | 15 | 150 | 10000 | 15000 |
| C15 | | | | | | | (not peeled) | (peeled) |
| Comp Ex | 12 | 1.2 | 8 | 12 | 20 | 150 | 15000 | 18000 |
| C16 | | | | | | | (peeled) | (peeled) |
| Comp Ex | 5.0 | 1.3 | 8 | 12 | 15 | 150 | 15000 | 18000 |
| C17 | | | | | | | (peeled) | (peeled) |
| Comp Ex | 5.0 | 1.5 | 8 | 12 | 17 | 150 | 18000 | 20000 |
| C18 | | | | | | | (peeled) | (peeled) |
| Comp Ex | 5.0 | 1.7 | 8 | 12 | 20 | 150 | 18000 | 20000 |
| C19 | | | | | | | (peeled) | (peeled) |

Notes:
As the metallic substrate of the separator, a material formed by a clad rolling junction and a finishing rolling of SUS and Ti was used. The intermediate layer has a double-layered structure.
Comp Ex: Comparative Example

As shown in FIG. 3, if the upper intermediate layer has an average thickness of more than 1 nm, an increase in hydrogen absorption may be caused, however, if the layer has a slight thickness, it can prevent the hydrogen absorption.

### Examples A1 to A12

Twelve kinds of samples of the metallic separator using the board material shown in FIG. 4A were prepared by changing the average thickness of the Au layer and simultaneously changing the Pd concentration of pure Ti (Pd concentration is 0 wt %) and Ti—Pd as the intermediate layer within the range of 5 to 20 wt %, and then, fuel cells were assembled by that the above-mentioned samples were used as the cathode surface, and further, the fuel cells were subjected to the cell test.

In the present experiment, the metallic separator for the anode is also required. Therefore, as the metallic separator for the anode in the present experiment, the same metallic separator as the sample of Example D5 was used.

### Comparative Examples D1 to D19

Nineteen kinds of samples of the metallic separator using the board material shown in FIG. 4A were prepared by changing the average thickness of the Au layer and simultaneously changing the Pd concentration of pure Ti (Pd concentration is 0 wt %) and Ti—Pd as the intermediate layer within the range of 5 to 30 wt %, and then, fuel cells were assembled by that the above-mentioned samples were used as the cathode surface, and further, the fuel cells were subjected to the cell test.

In the present experiment, the metallic separator for the anode is also required. Therefore, as the metallic separator for the anode in the present experiment, the same metallic separator as the sample of Example D5 was used.

The present experiment provides evidence that it is a preferably applicable range that the average thickness of the Au layer is 2 nm to 15 nm and the Pd concentration of the intermediate layer is not more than 20 wt %.

TABLE 4

| | Thickness of Au | | | | | | | |
|---|---|---|---|---|---|---|---|---|
| | layer | | Resistance of | | | | | |
| | Pd Concentration | | separator | | | | | |
| | of intermediate | | (mΩ · cm²) | | | Hydrogen content per Ti layer | | |
| | layer | | | Operation | | (ppm) (result of peeling test) | | |
| | Thickness of Au | Pd concentration | | hours | | | Operation hours | |
| Sample name | layer (nm) | (wt %) | Initial | 500 h | 5000 h | Initial | 500 h | 5000 h |
| Comp Ex | 0.8 | 0 | 15 | 60 | 450 | 150 | 200 | 600 |
| D1 | | | | | | | (not peeled) | (not peeled) |
| Comp Ex | 1.0 | 0 | 9 | 20 | 120 | 150 | 200 | 400 |
| D2 | | | | | | | (not peeled) | (not peeled) |
| Example | 2.0 | 0 | 8 | 12 | 15 | 150 | 200 | 400 |
| D1 | | | | | | | (not peeled) | (not peeled) |
| Example | 5.0 | 0 | 8 | 10 | 12 | 150 | 200 | 400 |
| D2 | | | | | | | (not peeled) | (not peeled) |
| Example | 12 | 0 | 8 | 11 | 11 | 150 | 200 | 400 |
| D3 | | | | | | | (not peeled) | (not peeled) |
| Example | 15 | 0 | 8 | 10 | 15 | 150 | 200 | 400 |
| D4 | | | | | | | (not peeled) | (not peeled) |
| Comp Ex | 17 | 0 | 8 | 10 | 16 | 150 | 200 | 400 |
| D3 | | | | | | | (not peeled) | (not peeled) |
| Comp Ex | 20 | 0 | 8 | 10 | 20 | 150 | 200 | 400 |
| D4 | | | | | | | (not peeled) | (not peeled) |
| Comp Ex | 1.0 | 5 | 9 | 30 | 180 | 150 | 200 | 200 |
| D5 | | | | | | | (not peeled) | (not peeled) |
| Example | 2.0 | 5 | 8 | 11 | 13 | 150 | 200 | 200 |
| D5 | | | | | | | (not peeled) | (not peeled) |
| Example | 12 | 5 | 8 | 9 | 12 | 150 | 200 | 200 |
| D6 | | | | | | | (not peeled) | (not peeled) |
| Example | 15 | 5 | 8 | 9 | 12 | 150 | 200 | 200 |
| D7 | | | | | | | (not peeled) | (not peeled) |
| Comp Ex | 17 | 5 | 8 | 10 | 20 | 150 | 200 | 200 |
| D6 | | | | | | | (not peeled) | (not peeled) |
| Comp Ex | 1.0 | 15 | 9 | 25 | 100 | 150 | 200 | 300 |
| D7 | | | | | | | (not peeled) | (not peeled) |
| Example | 2.0 | 15 | 8 | 10 | 11 | 150 | 200 | 300 |
| D8 | | | | | | | (not peeled) | (not peeled) |
| Example | 15 | 15 | 8 | 9 | 11 | 150 | 200 | 300 |
| D9 | | | | | | | (not peeled) | (not peeled) |
| Comp Ex | 17 | 15 | 8 | 11 | 16 | 150 | 200 | 300 |
| D8 | | | | | | | (not peeled) | (not peeled) |
| Comp Ex | 1.0 | 20 | 9 | 25 | 90 | 150 | 200 | 400 |
| D9 | | | | | | | (not peeled) | (not peeled) |
| Example | 2.0 | 20 | 8 | 10 | 11 | 150 | 200 | 400 |
| D10 | | | | | | | (not peeled) | (not peeled) |
| Example | 12 | 20 | 8 | 9 | 10 | 150 | 200 | 400 |
| D11 | | | | | | | (not peeled) | (not peeled) |
| Example | 15 | 20 | 8 | 9 | 10 | 150 | 200 | 400 |
| D12 | | | | | | | (not peeled) | (not peeled) |
| Comp Ex | 17 | 20 | 8 | 12 | 20 | 150 | 200 | 400 |
| D10 | | | | | | | (not peeled) | (not peeled) |
| Comp Ex | 1.0 | 25 | 9 | 40 | 70 | 150 | 200 | 1000 |
| D11 | | | | | | | (not peeled) | (not peeled) |
| Comp Ex | 2.0 | 25 | 8 | 10 | 30 | 150 | 200 | 1000 |
| D12 | | | | | | | (not peeled) | (not peeled) |
| Comp Ex | 15 | 25 | 8 | 9 | 27 | 150 | 200 | 1000 |
| D13 | | | | | | | (not peeled) | (not peeled) |
| Comp Ex | 17 | 25 | 8 | 12 | 33 | 150 | 200 | 1000 |
| D14 | | | | | | | (not peeled) | (not peeled) |
| Comp Ex | 1.0 | 30 | 9 | 40 | 70 | 150 | 200 | 2500 |
| D15 | | | | | | | (not peeled) | (not peeled) |
| Comp Ex | 2.0 | 30 | 8 | 12 | 40 | 150 | 500 | 2500 |
| D16 | | | | | | | (not peeled) | (not peeled) |
| Comp Ex | 12 | 30 | 8 | 12 | 30 | 150 | 500 | 2500 |
| D17 | | | | | | | (not peeled) | (not peeled) |
| Comp Ex | 15 | 30 | 8 | 12 | 35 | 150 | 500 | 2500 |
| D18 | | | | | | | (not peeled) | (not peeled) |
| Comp Ex | 17 | 30 | 8 | 12 | 40 | 150 | 500 | 2500 |
| D19 | | | | | | | (not peeled) | (not peeled) |

Notes:
As the metallic substrate for cathode of the separator, a material formed by a clad rolling junction and a finishing rolling of SUS and Ti was used.
Comp Ex: Comparative Example

FIGS. 4A, 4B show that also the cathode (air electrode) causes hydrogen absorption in the cell operation environment though not so large as the anode (hydrogen electrode), and it is preferable that the intermediate layer has an appropriate Pd concentration.

It is preferable that the Au layer in case of the cathode is rather thicker than in case of the anode. It is supposed that the reason why even if the average thickness is more than 9 nm durability is not harmed is that the hydrogen absorption is small so that the layer is decreased in an amount of strain. Further, it is supposed that the reason why the average thickness needs 2 nm is that it is placed under an oxidation atmosphere.

### Examples E1 to E12

Next, the experimental result in the case that the intermediate layer includes the lower intermediate layer and the upper intermediate layer will be described. The lower intermediate layer composed of pure Ti was prepared. The average thickness of the lower intermediate layer was set to about 20 nm, and samples were prepared by changing the average thickness of the upper intermediate layer composed of pure Pd from 0.2 nm to 2.0 nm.

Further, twelve kinds of samples were prepared by changing the average thickness of the Au layer composed of pure Au (purity: 3N) from 2 nm to 15 nm. And then, fuel cells were assembled by that the above-mentioned samples were used as the cathode surface, and further, the fuel cells were subjected to the cell test. As the metallic separator for the anode in the present experiment, the same metallic separator as the sample of Example E3 was used.

### Comparative Examples E1 to E19

The lower intermediate layer composed of pure Ti was prepared. The average thickness of the lower intermediate layer was set to about 20 nm, and samples were prepared by changing the average thickness of the upper intermediate layer composed of pure Pd from 0.2 nm to 3.3 nm.

Further, nineteen kinds of samples were prepared by changing the average thickness of the Au layer composed of pure Au (purity: 3N) from 0.8 nm to 20 nm. And then, fuel cells were assembled by that the above-mentioned samples were used as the cathode surface, and further, the fuel cells were subjected to the cell test. As the metallic separator for the anode in the present experiment, the same metallic separator as the sample of Example E3 was used. The present experiment provides evidence that it is a preferably applicable range that the average thickness of the Au layer is 2 nm to 15 nm and the average thickness of the upper intermediate layer is not more than 2 nm.

TABLE 5

| | Thickness of Au | | | | | | | |
|---|---|---|---|---|---|---|---|---|
| | layer | | Resistance of | | | | | |
| | Thickness of upper | | separator | | | | | |
| | intermediate layer | | (mΩ · cm²) | | | Hydrogen content per Ti layer | | |
| | | Thickness of upper | | Operation | | (ppm) (result of peeling test) | | |
| | Thickness of Au | intermediate layer | | hours | | | Operation hours | |
| Sample name | layer (nm) | (nm) | Initial | 500 h | 5000 h | Initial | 500 h | 5000 h |
| Comp Ex | 0.8 | 0.2 | 13 | 25 | 100 | 150 | 200 | 200 |
| E1 | | | | | | | (not peeled) | (not peeled) |
| Comp Ex | 1.0 | 0.2 | 9 | 15 | 40 | 150 | 200 | 200 |
| E2 | | | | | | | (not peeled) | (not peeled) |
| Example | 2.0 | 0.2 | 8 | 11 | 13 | 150 | 200 | 200 |
| E1 | | | | | | | (not peeled) | (not peeled) |
| Example | 5.0 | 0.2 | 8 | 9 | 10 | 150 | 200 | 200 |
| E2 | | | | | | | (not peeled) | (not peeled) |
| Example | 9.0 | 0.2 | 8 | 9 | 9 | 150 | 200 | 200 |
| E3 | | | | | | | (not peeled) | (not peeled) |
| Example | 15 | 0.2 | 8 | 9 | 12 | 150 | 200 | 200 |
| E4 | | | | | | | (not peeled) | (not peeled) |
| Comp Ex | 17 | 0.2 | 8 | 12 | 18 | 150 | 200 | 200 |
| E3 | | | | | | | (not peeled) | (not peeled) |
| Comp Ex | 20 | 0.2 | 8 | 13 | 25 | 150 | 200 | 200 |
| E4 | | | | | | | (not peeled) | (not peeled) |
| Comp Ex | 1.0 | 0.4 | 9 | 15 | 30 | 150 | 200 | 200 |
| E5 | | | | | | | (not peeled) | (not peeled) |
| Example | 2.0 | 0.4 | 8 | 11 | 12 | 150 | 200 | 200 |
| E5 | | | | | | | (not peeled) | (not peeled) |
| Example | 15 | 0.4 | 8 | 9 | 11 | 150 | 200 | 200 |
| E6 | | | | | | | (not peeled) | (not peeled) |
| Comp Ex | 17 | 0.4 | 8 | 9 | 20 | 150 | 200 | 200 |
| E6 | | | | | | | (not peeled) | (not peeled) |
| Comp Ex | 1.0 | 1.0 | 9 | 12 | 30 | 150 | 200 | 200 |
| E7 | | | | | | | (not peeled) | (not peeled) |
| Example | 2.0 | 1.0 | 8 | 11 | 13 | 150 | 200 | 200 |
| E7 | | | | | | | (not peeled) | (not peeled) |
| Example | 15 | 1.0 | 8 | 10 | 12 | 150 | 200 | 200 |
| E8 | | | | | | | (not peeled) | (not peeled) |
| Comp Ex | 17 | 1.0 | 8 | 9 | 21 | 150 | 200 | 200 |
| E8 | | | | | | | (not peeled) | (not peeled) |
| Comp Ex | 1.0 | 1.8 | 9 | 13 | 32 | 150 | 300 | 500 |
| E9 | | | | | | | (not peeled) | (not peeled) |
| Example | 2.0 | 1.8 | 8 | 11 | 13 | 150 | 300 | 500 |
| E9 | | | | | | | (not peeled) | (not peeled) |
| Example | 15 | 1.8 | 8 | 10 | 11 | 150 | 300 | 500 |
| E10 | | | | | | | (not peeled) | (not peeled) |
| Comp Ex | 17 | 1.8 | 8 | 9 | 25 | 150 | 300 | 500 |
| E10 | | | | | | | (not peeled) | (not peeled) |
| Comp Ex | 1.0 | 2.0 | 9 | 9 | 33 | 150 | 500 | 600 |
| E11 | | | | | | | (not peeled) | (not peeled) |
| Example | 2.0 | 2.0 | 8 | 12 | 15 | 150 | 500 | 600 |
| E11 | | | | | | | (not peeled) | (not peeled) |
| Example | 15 | 2.0 | 8 | 10 | 14 | 150 | 500 | 600 |
| E12 | | | | | | | (not peeled) | (not peeled) |
| Comp Ex | 17 | 2.0 | 8 | 10 | 22 | 150 | 500 | 600 |
| E12 | | | | | | | (not peeled) | (not peeled) |
| Comp Ex | 1.0 | 2.3 | 9 | 9 | 40 | 150 | 600 | 1000 |
| E13 | | | | | | | (not peeled) | (not peeled) |
| Comp Ex | 2.0 | 2.3 | 8 | 11 | 18 | 150 | 600 | 1000 |
| E14 | | | | | | | (not peeled) | (not peeled) |
| Comp Ex | 15 | 2.3 | 8 | 10 | 20 | 150 | 600 | 1000 |
| E15 | | | | | | | (not peeled) | (not peeled) |
| Comp Ex | 17 | 2.3 | 8 | 12 | 20 | 150 | 600 | 1000 |
| E16 | | | | | | | (not peeled) | (not peeled) |
| Comp Ex | 15 | 2.7 | 8 | 12 | 45 | 150 | 700 | 1500 |
| E17 | | | | | | | (not peeled) | (not peeled) |
| Comp Ex | 15 | 3.0 | 8 | 12 | 110 | 150 | 800 | 2000 |
| E18 | | | | | | | (not peeled) | (not peeled) |
| Comp Ex | 15 | 3.3 | 8 | 12 | 200 | 150 | 800 | 25000 |
| E19 | | | | | | | (not peeled) | (not peeled) |

Notes:
As the metallic substrate for cathode of the separator, a material formed by a clad rolling junction and a finishing rolling of SUS and Ti was used. The intermediate layer has a double-layered structure.
Comp Ex: Comparative Example

As shown in FIG. 5, if the upper intermediate layer has an average thickness of more than 2 nm, increase in hydrogen absorption may be caused, however, if the layer has a slight thickness, it can prevent the hydrogen absorption.

The verification method of these average thicknesses in Examples described above includes an analysis method using such as an ICP (induction coupled plasma) mass analysis, or an XPS (X-ray photoemission spectroscopy). The method described above can measure the average thickness of the layers respectively, by means that plural random places being desired to be measured of the metal member with electric contact layer are used as analysis samples.

Further, an analysis method using a TEM (transmission electron microscope) can also measure the average thickness as well as the IPC and XPS.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A board material for a fuel cell metallic separator, comprising:
a metallic substrate;
an intermediate layer formed on a surface of the metallic substrate, and comprising titanium (Ti); and
a Au layer formed on a surface of the intermediate layer, comprising pure gold (Au), and having an average thickness of not less than 1 nm and not more than 9 nm.

2. The board material according to claim 1, wherein the intermediate layer comprises not more than 5 wt % of palladium (Pd) relative to a Ti content thereof.

3. A board material for a fuel cell metallic separator, comprising:
a metallic substrate;
a lower intermediate layer formed on a surface of the metallic substrate, and comprising titanium (Ti);
an upper intermediate layer formed on a surface of the lower intermediate layer, comprising a Pd layer, and having an average thickness of not more than 1 nm; and
a Au layer formed on the surface of the upper intermediate layer, comprising pure gold (Au), and having an average thickness of not less than 1 nm and not more than 9 nm.

4. A board material for a fuel cell metallic separator, comprising:
a metallic substrate;
an intermediate layer formed on the surface of the metallic substrate, and comprising titanium (Ti); and
a Au layer formed on the surface of the intermediate layer, comprising pure gold (Au), and having an average thickness of not less than 2 nm and not more than 15 nm.

5. The board material according to claim 4, wherein the intermediate layer-comprises not more than 20 wt % of palladium (Pd) to the Ti content thereof.

6. A board material for a fuel cell metallic separator for covering an oxidant electrode side of an MEA (membrane electrode assembly), comprising:
a metallic substrate;
a lower intermediate layer formed on a surface of the metallic substrate, comprising titanium (Ti);
an upper intermediate layer formed on a surface of the lower intermediate layer, comprising a Pd layer, and having an average thickness of not more than 2 nm; and
a Au layer formed on a surface of the upper intermediate layer, comprising pure gold (Au), and having an average thickness of not less than 2 nm and not more than 15 nm.

7. A fuel cell metallic separator, comprising:
the board material according to claim 1,
wherein the board material comprises a concavo-convex shape.

8. A method of making a board material for a fuel cell metallic separator, comprising:
forming an intermediate layer on a surface of a metallic substrate by a gas-phase process in a chamber, the intermediate layer comprising titanium (Ti); and
forming a Au layer on a surface of the intermediate layer by a gas-phase process in the same chamber, the Au layer comprising pure gold (Au) and having an average thickness of not less than 1 nm and not more than 9 nm.

9. A method according to claim 8, wherein the intermediate layer comprises not more than 5 wt % of palladium (Pd) relative to a Ti content thereof.

10. A method of making a board material for a fuel cell metallic separator, comprising:
forming a lower intermediate layer on a surface of a metallic substrate by a gas-phase process in a chamber, the intermediate layer comprising titanium (Ti);
forming an upper intermediate layer on a surface of the lower intermediate layer, the upper intermediate layer comprising a palladium (Pd) layer and having an average thickness of not more than 1 nm; and
forming a Au layer on a surface of the upper intermediate layer by a gas-phase process in the same chamber, the Au layer comprising pure gold (Au) and having an average thickness of not less than 1 nm and not more than 9 nm.

11. A method of making a board material for a fuel cell metallic separator for covering an oxidant electrode side of an MEA (membrane electrode assembly), comprising:
forming an intermediate layer on a surface of a metallic substrate by a gas-phase process in a chamber, the intermediate layer comprising titanium (Ti); and
forming a Au layer on a surface of the intermediate layer by a gas-phase process in the same chamber, the Au layer comprising pure gold (Au) and having an average thickness of not less than 2 nm and not more than 15 nm.

12. A method according to claim 11, wherein the intermediate layer comprises not more than 20 wt % of palladium (Pd) relative to a Ti content thereof.

13. A method of making a board material for a fuel cell metallic separator for covering an oxidant electrode side of an MEA (membrane electrode assembly), comprising:
forming a lower intermediate layer on a surface of a metallic substrate by a gas-phase process in a chamber, the intermediate layer comprising titanium (Ti);
forming an upper intermediate layer on a surface of the lower intermediate layer comprising a palladium (Pd) layer and having an average thickness of not more than 2 nm; and
forming a Au layer on a surface of the upper intermediate layer by a gas-phase process in the same chamber, the Au layer comprising pure gold (Au) and having an average thickness of not less than 2 nm and not more than 15 nm.

14. A fuel cell metallic separator, comprising:
the board material according to claim 3,
wherein the board material comprises a concavo-convex shape.

15. A fuel cell metallic separator, comprising:
the board material according to claim 4,
wherein the board material comprises a concavo-convex shape.

16. A fuel cell metallic separator, comprising:
the board material according to claim 6,
wherein the board material comprises a concavo-convex shape.
